(19) United States
(12) Patent Application Publication
(10) Pub. No.: US 2024/0064465 A1
(43) Pub. Date: Feb. 22, 2024

(54) THERMALLY EFFICIENT SPEAKER

(71) Applicants: Franco L D'Ascanio, Key Colony Beach, FL (US); Sean P Snowden, Marathon, FL (US); Harold M. Zimmermann, Riverton, NJ (US)

(72) Inventors: Franco L D'Ascanio, Key Colony Beach, FL (US); Sean P Snowden, Marathon, FL (US); Harold M. Zimmermann, Riverton, NJ (US)

(21) Appl. No.: 18/447,513

(22) Filed: Aug. 10, 2023

Related U.S. Application Data
(60) Provisional application No. 63/398,342, filed on Aug. 16, 2022.

(51) Int. Cl. H04R 9/02; H04R 9/06; H04R 1/02; H04R 5/02

(52) U.S. Cl. CPC H04R 9/022; H04R 9/06; H04R 1/025; H04R 5/02; H04R 2400/11; H04R 2201/021

(57) ABSTRACT

A thermally efficient speaker is attached to a thermally conductive, e.g. aluminum, speaker casing which has been thermally engineered to transfer heat generated from the speaker to the casing. As a result, the casing becomes an interactive heat sink to cool the speaker; thus, greatly improving the power, handling, reliability, and longevity of the speaker.

### RELATED APPLICATION

The application claims the benefit of provisional application 63/398,342, filed on Aug. 16, 2022.

### FIELD OF THE INVENTION

The present invention relates to speaker systems and, more particularly, to speakers having means to effectively transfer heat generated by speakers.

### BACKGROUND OF THE INVENTION

During the operation of an audio speaker, heat is generated within the speaker's casing or like enclosure. A typical speaker enclosure has poor thermal transfer resulting in the build-up and confinement of heat within the enclosure. This concentrated, enclosed heat, rather than being dissipated into surrounding air, causes speaker performance degradation, sound distortion, notably reduced power handling, and generally reduction of speaker reliability and longevity.

### SUMMARY OF THE INVENTION

It is thus the object of the present invention to provide a speaker and speaker system which simply, efficiently, and effectively transfers heat generated by a speaker, through its speaker casing, into the surrounding air.

This and other objects are accomplished by the present invention, a speaker and speaker system which comprises a speaker attached to a thermally conductive, e.g. aluminum, speaker casing which has been thermally engineered to transfer heat generated from the speaker to the casing. As a result, the casing becomes an interactive heat sink to cool the speaker; thus, greatly improving the power, handling, reliability, and longevity of the speaker.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 illustrates the manner heat builds up and is concentrated in a common speaker system.

FIG. 2 shows the speaker system of the present invention, illustrating the manner heat is dissipated to the air outside the speaker enclosure.

FIG. 3 is a partial cross-section of the speaker system of the present invention.

FIG. 4 is a front view of the speaker of the present invention.

FIG. 5 is a front view of several speakers of the present invention mounted in a speaker enclosure.

FIG. 6 is a perspective view of the mounted speakers shown in FIG. 5.

FIGS. 7-14a illustrate the ways the speaker of the present invention can be utilized in different speaker mountings and locations.

### DETAILED DESCRIPTION OF THE INVENTION

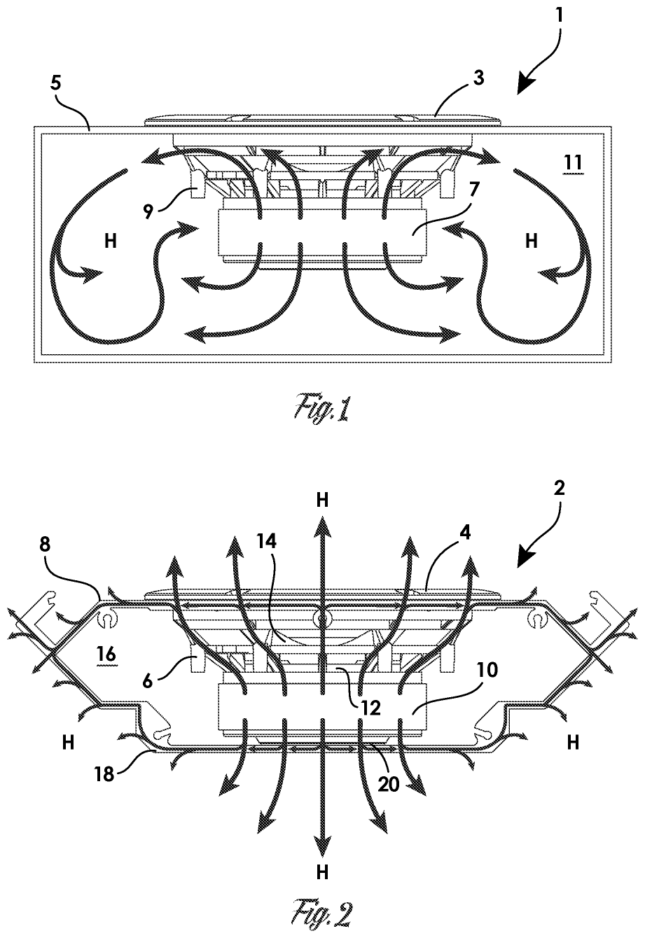

FIG. 1 is an example of how heat H from a prior art speaker system 1 is generated by a heat source, here motor system 7, within speaker 3. The heat from motor system 7 builds up within a typical, non-conductive speaker casing 5, and it circulates and recirculates within non-conductive speaker frame 9, heating up the entire interior space 11 of speaker system 1.

Speaker system 2 of the present invention comprises speaker 4 connected by speaker frame 6, made of thermally conductive speaker material such as aluminum, to the front of speaker casing 8, also made of aluminum or like thermally conductive material. Casing 8 encompasses speaker 4 and casing interior space 16. Motor system 10, a rear component of speaker 4, has a thermal transfer medium, e.g. thermal transfer pad 20, attached to the bottom of the motor system. Thermal transfer pad 20 is located adjacent to, against, and in direct contact with rear wall 18 of casing 8. This design creates a superior thermal path between speaker 4 and casing 8 for highly effective thermal transfer between speaker voice coil 12 and the walls of the casing.

Voice coil 12 further enhances thermal transfer from the voice coil to motor system 10 to casing 8. Aluminum core 14 of speaker 4 is in constant motion and also transfers heat from attached voice coil 12 to outside of speaker system 1. The trapezoidal shape of casing 8 is designed to maximize the surface area of the casing for maximum cooling through the casing.

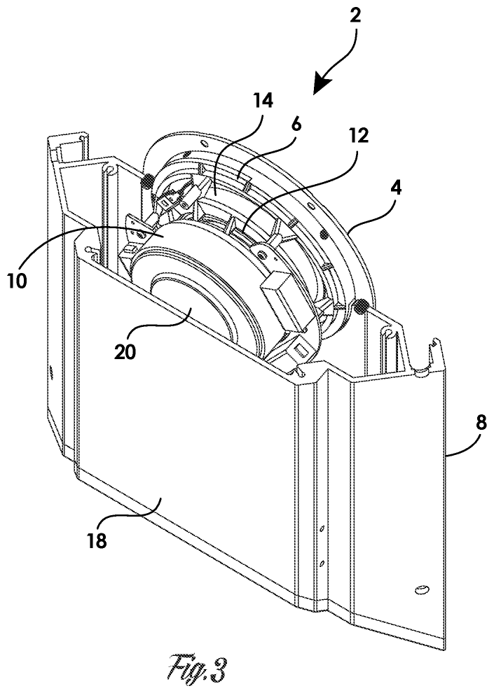

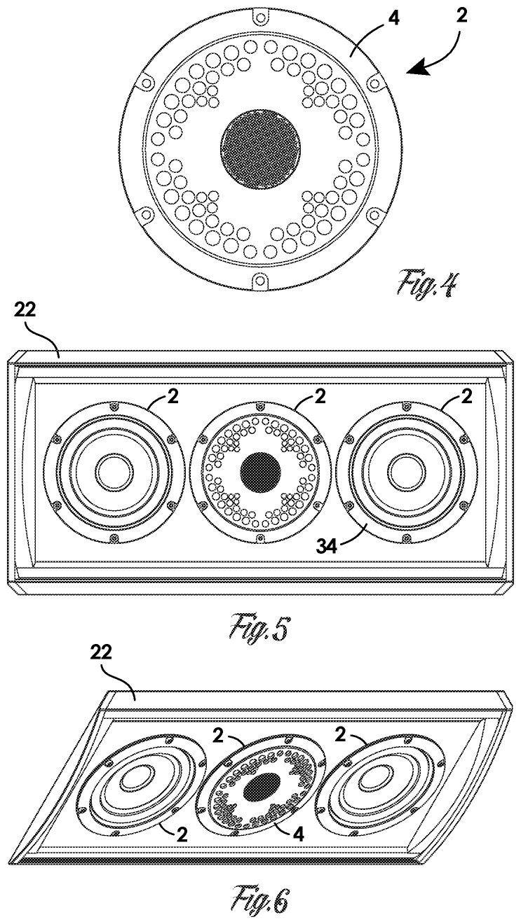

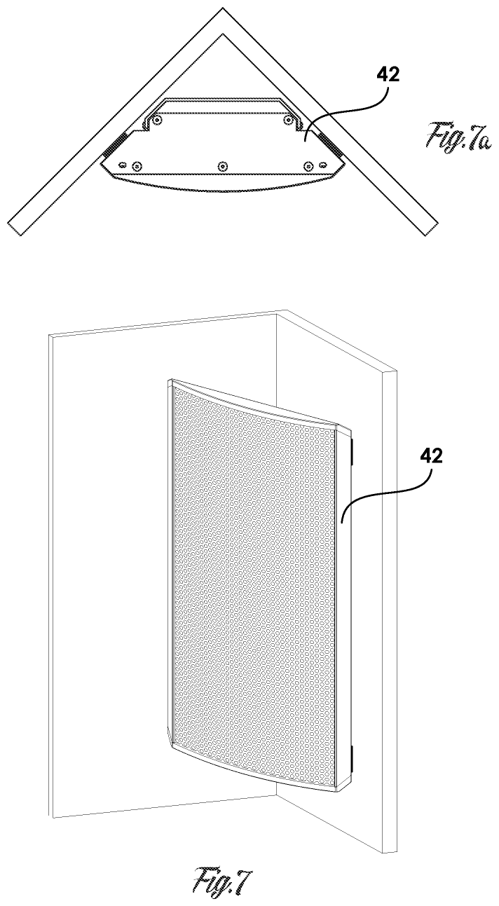

The directional arrows from speaker 4 through casing 8, as seen in FIG. 2, illustrates the various paths in which heat H built up in interior space 16 during speaker operation exits through casing 8 to the surrounding space outside of speaker system 2.

FIGS. 5 and 6 show exterior views of speakers 2, mounted within speaker enclosure 22.

FIG. 7 is a perspective view of the speaker of the present invention mounted as corner speaker 42. FIG. 7a is the top view of the speaker of the present invention mounted as a corner speaker.

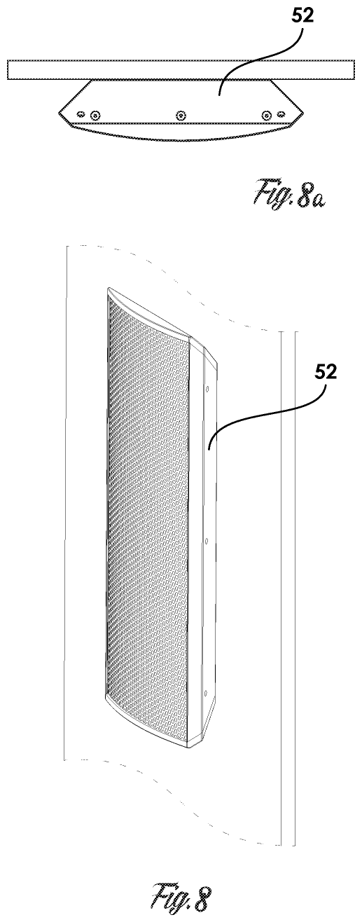

FIG. 8 is a perspective view of the speaker of the present invention mounted as surface wall speaker 52. FIG. 8a is the top view of the speaker of the present invention mounted as a surface wall speaker.

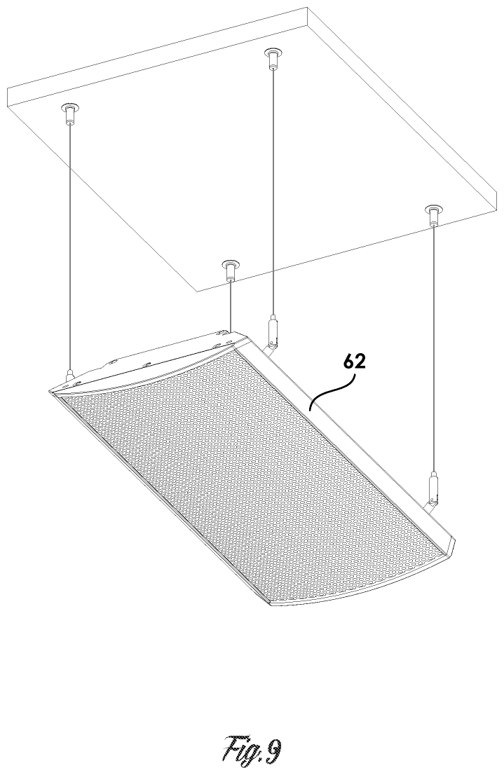

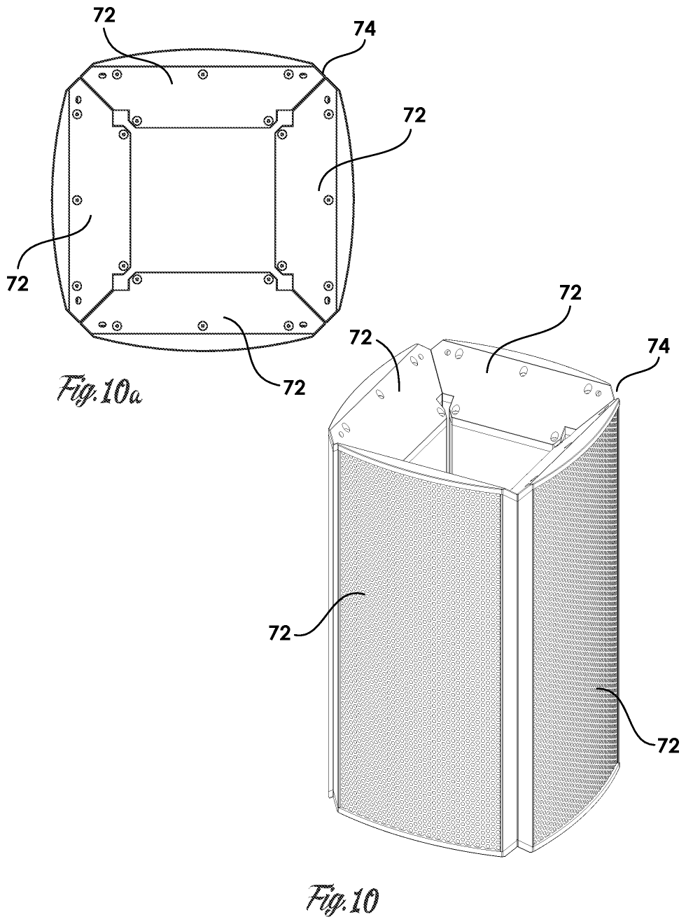

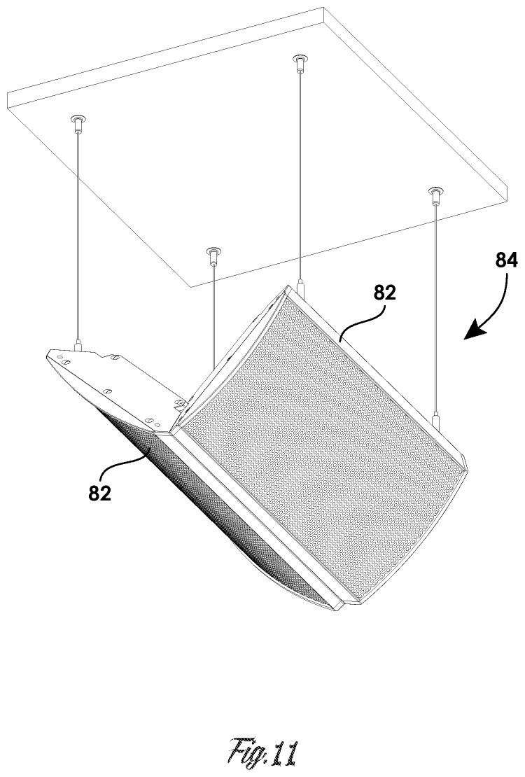

FIG. 9 is a perspective view of the speaker of the present invention 62 mounted as a speaker hanging from the ceiling or other overhead.

FIG. 10 is a perspective view of the speaker of the present invention 72 connected as a quad speaker unit 74. FIG. 10a is the top view of the speaker of the present invention connected as the quad speaker unit.

FIG. 11 is a perspective view of the speaker of the present invention 82 hanging from the ceiling or other overhead as dual stereo system 84.

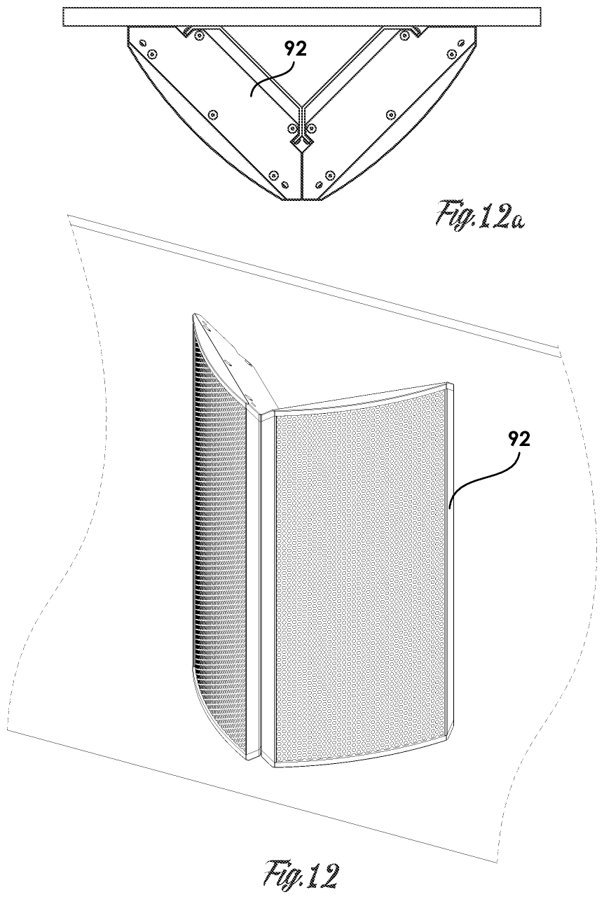

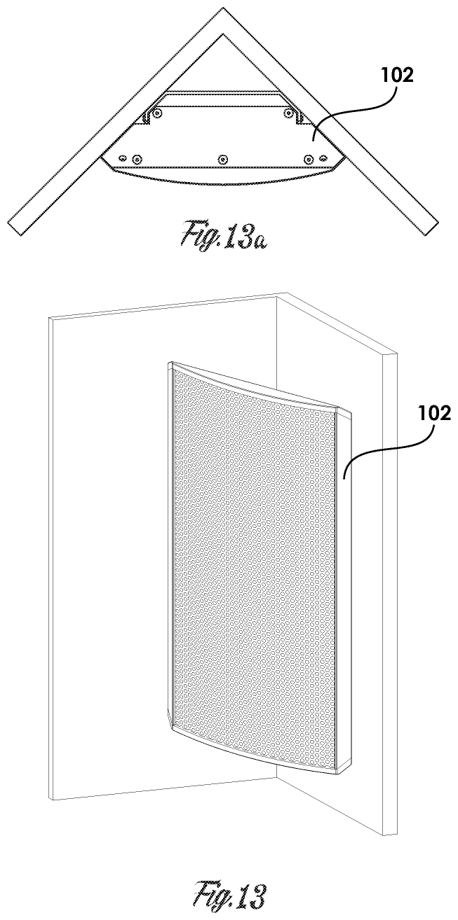

FIG. 12 is a perspective view of the speaker of the present invention 92 mounted as a dual stereo wall system. FIG. 12a is the top view of the speaker of the present invention mounted as the dual stereo wall system.

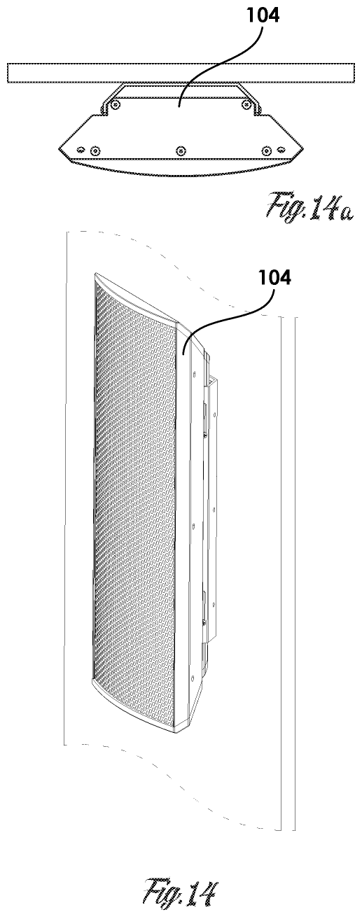

FIG. 13 is a perspective view of the speaker of the present invention 102 mounted as a corner speaker with standoff. FIG. 13a is the top view of the speaker of the present invention mounted as a corner speaker with standoff.

FIG. 14. is a perspective view of the speaker of the present invention 104 mounted as a recessed wall speaker. FIG. 14a is the top view of the speaker of the present invention mounted as a recessed wall speaker.

The thermally efficient speaker system of the present invention provides the following significant features and advantages:
The speaker acts as a structural brace to mitigate unwanted enclosure vibrations. This direct connection creates a thermal transfer utilizing the entire aluminum enclosure as a heatsink for the speaker, resulting in improved performance.
The voice coil and aluminum cone further enhance thermal transfer through active management (via the aluminum cone), direct transfer to the enclosure front (via the driver frame), and the rear of the enclosure (via the driver motor system).
Flexible modular construction allows for numerous applications and performance levels.
Audio performance changes are based on the number of enclosures and configuration type.
Acoustic filter “fractal” waveguide coax bridge is provided.
Speaker enclosures can become electronics enclosures once speaker drivers are removed.
A combination of speaker enclosures and electronics enclosures can be joined together (Quad configuration shown in FIG. 10 is a good example).
Omni (Quad) configuration minimizes comb-filtering with full-range drivers on two sides and a modified driver output on the remaining two sides, thus preventing cancellation.
The EVA anti-diffraction diffusers can be added/removed for variable tuning (absorptive or reflective).
Integrated mounting (part of the enclosure) and universal mounting bracket (an accessory) for surface, corner, hanging, ganging, and post mounting can be provided. Direct wall/corner mounting is possible through the integrated mounting feature of the enclosure.
Integrated notch on the rear of the enclosure facilitates semi-recessed wall mounting.

The same integrated notch becomes a channel for running wiring or irrigation for plants, when ganging enclosures.
The use of angled endcaps and mounting holes will allow for rainwater to drain.
The ability to gang the enclosures to form a planter, fire pit, or other configuration.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A thermally efficient speaker for transferring heat generated within the speaker to surroundings externally of the speaker, said thermally efficient speaker comprising:
a speaker frame fabricated of a thermally conductive material, said frame enclosing a speaker voice coil and a speaker core;
a speaker casing fabricated of a thermally conductive material connected at the front of the speaker casing to the speaker frame;
a motor system extending from the voice coil, said motor system attached at its lower end to a thermal transfer medium, said thermal transfer medium being located adjacent to, against, and in direct contact with the speaker casing; wherein heat generated by the speaker voice coil and the motor system is transferred from said speaker voice coil and said motor system through the speaker casing to the surrounding area outside the speaker casing for reducing heat generated within the speaker and thereby cool the speaker.

2. The thermally efficient speaker as in claim 1 wherein the thermal transfer medium is located adjacent to, against, and in direct contact with the rear wall of the speaker casing.

3. The thermally efficient speaker as in claim 1 wherein the thermal transfer medium is a thermal transfer pad.

4. The thermally efficient speaker as in claim 1 wherein the speaker casing has a trapezoidal shape.

5. The thermally efficient speaker as in claim 1 wherein the speaker is configured to be a corner mounted speaker.

6. The thermally efficient speaker as in claim 1 wherein the speaker is configured to be a wall surface mounted speaker.

7. The thermally efficient speaker as in claim 1 wherein the speaker is configured to be hung from the ceiling or generally overhead.

8. The thermally efficient speaker as in claim 1 wherein the speaker is configured to be utilized as a quad speaker unit.

9. The thermally efficient speaker as in claim 1 wherein the speaker is configured to be hung from the ceiling, or generally overhead as a dual stereo system.

10. The thermally efficient speaker as in claim 1 wherein the speaker is configured to be wall surface mounted as a dual stereo system.

11. The thermally efficient speaker as in claim 1 wherein the speaker is configured to be a standoff corner mounted speaker.

12. The thermally efficient speaker as in claim 1 wherein the speaker is configured to be a recessed wall mounted speaker.
